(19) United States
(12) Patent Application Publication
(10) Pub. No.: US 2006/0204739 A1
(43) Pub. Date: Sep. 14, 2006

(54) Pultrusion method and an article produced by said method

(75) Inventors: Nicolai Papke, Maime-Kastel (DE); Joachim Heydweiller, Russelsheim (DE); Heinz Bernd, Heppenheim (DE); Bruno Wagner, Brechen (DE); Thomas Borgner, Bischofsheim (DE); Brigitte Littwitz, Frankfurt (DE)

Correspondence Address: CONNOLLY BOVE LODGE & HUTZ, LLP, P O BOX 2207, WILMINGTON, DE, 19899, US

(73) Assignee: TICONA GmbH, Ketsterbach (DE)

(21) Appl. No.: 10/554,894

(22) PCT Filed: Apr. 29, 2004
(86) PCT No.: PCT/EP04/04519

§ 371 Date: Apr. 6, 2006

(30) Foreign Application Priority Data
Apr. 30, 2003 (DE) 103 19 237.9

(51) Int. Cl. B29C 70/52

(52) U.S. Cl. 428/297.4; 156/180; 156/166; 264/136

(57) ABSTRACT

A pultrusion process is described, in which a strand composed of a multifilament-reinforced first thermoplastic molding composition is produced, sheathed by a layer composed of a second thermoplastic molding composition. The first molding composition here comprises a catalyst which catalyzes the formation of covalent bonds between the thermoplastic polymer and the surface of the multifilaments, and, where appropriate, comprises other additives which do not adversely affect the activity of the catalyst, and the second thermoplastic molding composition comprises additives.

The present invention relates to a pultrusion process which can produce rods with improved fiber-plastic adhesion, and to the products produced thereby.

It is known that thermoplastics can be combined with additives, such as reinforcing materials, fillers, and/or impact modifiers, in order to improve their mechanical properties, such as strength or impact resistance, or to reduce their price.

The effect of reinforcing materials on the properties of the molding composition is affected via their linkage to the plastics matrix. Some reinforcing materials are therefore often not suitable for every plastic, or are provided with sizes which bring about improved linkage to the plastics matrix.

The reinforcing fibers here are coated with sizes, and these are incorporated into the molten polymer after drying of the size. A coupling agent is also often used in addition to the size, and is intended to improve the adhesion at the interface between the reinforcing material and the polymer matrix. However, this procedure is often inadequate.

A disadvantage with the use of sizes or of coupling agents in the production of reinforced molding compositions is often insufficient bonding of polymer matrix to the reinforcing material. Maximum bonding between these components of the molding composition is desirable.

Production of long-fiber-reinforced thermoplastics rods by means of pultrusion is known per se. This permits production of pellets or molding compositions from thermoplastics.

WO-A-99/65,661, corresponding to U.S. Pat. No. 6,090,319, proposes production by means of pultrusion processes of rods which have a sheath of another plastic.

The earlier WO-A-03/74,612, which is not a prior publication, discloses thermoplastic molding compositions and moldings produced therefrom, which comprise not only selected additives but also a catalyst which catalyzes formation of covalent bonds between the thermoplastic polymer and the surface of the additive. The description states that long-fiber-reinforced molding compositions can be prepared therefrom and can be sheathed with another material, such as a thermoplastic polymer.

Starting from this prior art, the object of the present invention was provision of long-fiber-reinforced thermoplastics rods with improved linkage of the thermoplastic to the reinforcement fiber.

Another object of the present invention consists in provision of rod- or pellet-shaped semifinished products which have a long-fiber-reinforced thermoplastics core in which there is a catalyst for improved linkage of the thermoplastic to the reinforcement fiber, but excluding the presence here of additives which can adversely affect the activity of the catalyst. Additives of this type are found in the sheath around the thermoplastics core.

The improved linkage of the reinforcement fiber to the plastics matrix is seen in increased interfacial adhesion and in improved mechanical properties of the semifinished product, and also of the moldings produced therefrom.

Another object of the present invention consisted in provision of a process for preparation of these semifinished products or molding compositions.

These objects are achieved via the process described below and the products produced therefrom.

The present invention relates to a process for production of long-fiber-reinforced molding compositions encompassing the steps of:
a) passing, over a surface, at least one multifilament strand of multifilaments subject to tension, so that in the at least one strand the multifilaments spread apart and form an opened multifilament strand,
b) introducing the opened multifilament strand subject to tension into a first impregnator,
c) conducting a first thermoplastic molding composition into the first impregnator, where the first thermoplastic molding composition comprises at least one thermoplastic polymer, at least one catalyst which catalyzes the formation of covalent bonds between the thermoplastic polymer and the surface of the multifilaments, and, where appropriate, comprises other additives which do not adversely affect the activity of the catalyst,
d) impregnating the at least one opened multifilament strand with the plastified first thermoplastic molding composition,
e) drawing-off of the fiber-reinforced strand formed from the first impregnator,
f) passing the fiber-reinforced strand into a second die,
g) conducting a second thermoplastic molding composition, other than the first thermoplastic molding composition and comprising at least one thermoplastic polymer and comprising additives, into the second die,
h) sheathing the fiber-reinforced strand with the plastified second thermoplastic molding composition in the second die,
i) drawing-off of the fiber-reinforced strand provided with a sheath composed of the second thermoplastic molding composition from the second die, and
j) where appropriate, cooling, molding, pelletizing and/or further processing of the fiber-reinforced strand provided with a sheath composed of the second thermoplastic molding composition.

The first impregnator and the introduction of the at least one strand of multifilaments involve a pultrusion die known per se. These dies are described by way of example in EP-A-579,047 or in U.S. Pat. No. RE 32,772.

Reinforcement fibers in opened condition and subject to tension are introduced into this pultrusion die, so that impregnation with the first thermoplastic molding composition can take place.

The reinforcement fibers can be any desired multifilament yarns composed of various materials.

Examples of these are rovings composed of high-strength materials. The rovings are preferably composed of continuous filaments.

The multifilaments used advantageously comprise mineral fibers, such as glass fibers, polymer fibers, and in particular organic high-modulus fibers, such as aramid fibers, or metal fibers, such as steel fibers, or carbon fibers.

These may be modified or unmodified fibers, for example provided with a size or chemically treated, in order to improve adhesion to the plastic.

Glass fibers are particularly preferred. The materials mostly used to treat glass fibers are organic silanes, in particular aminosilanes. By way of specific example, aminosilanes which may be used are 3-trimethoxysilylpropylamine, N-(2-aminoethyl)-3-aminopropyltrimethoxysilane, N-(3-trimethoxysilanylpropyl)ethane-1,2-diamine, 3-(2-aminoethyl-amino)propyltrimethoxysilane, N-[3-(trimethoxysilyl)propyl]-1,2-ethane-diamine.

Other materials which may be used with advantage are sizes based on polyurethanes.

It is preferable that from one to a hundred opened multifilament strands are introduced into the first impregnator.

The opening of the multifilament strands takes place in a manner known per se, as described in the abovementioned WO-A-99/65,661.

After introduction of the multifilament strand into the first impregnator, this is impregnated with a first thermoplastic molding composition, and a long-fiber-reinforced strand is formed. This is drawn off from the first impregnator. By virtue of the draw-off, in interaction with the feed devices for the multifilament yarns, tension is generated in these.

After leaving the first impregnator, the long-fiber-reinforced strand is introduced into a second die, where it is sheathed as described in WO-A-99/65,661 with a second thermoplastic molding composition.

After draw-off from the second die of the long-fiber-reinforced rod provided with a sheath, this rod can either be wound up in plastic condition or chopped into rods of predetermined length.

The fiber-reinforced strand provided with a sheath composed of the second thermoplastic molding composition is preferably cooled, molded, chopped into pellets, and/or further processed after leaving the second die.

The first thermoplastic molding composition comprises at least one thermoplastic polymer, at least one catalyst which catalyzes formation of covalent bonds between the thermoplastic polymer and the surface of the multifilaments, and, where appropriate, comprises other additives which do not adversely affect the activity of the catalyst.

The proportion of the thermoplastic polymer in the first thermoplastic molding composition is usually at least 60% by weight, preferably from 60 to 99.5% by weight, based on the weight of the first thermoplastic molding composition.

The proportion of the catalyst in the first thermoplastic molding composition is usually less than 1.0% by weight, preferably from 0.00001 to 1.0% by weight, and in particular from 0.001 to 0.5% by weight, based on the weight of the first thermoplastic molding composition.

The proportion of the additives present, where appropriate, in the first thermoplastic molding composition is usually up to 40% by weight, preferably from 0.1 to 15% by weight, and in particular from 0.1 to 10% by weight, based on the weight of the first thermoplastic molding composition.

The additives present, where appropriate, in the first thermoplastic molding composition can be any desired substances which can be useful during the processing of the pultruded semifinished product and/or which give the subsequent final product a desired property. However, the additives are to be selected in such a way that their presence does not adversely affect the activity of the catalyst.

Examples of additives are listed at a later stage below in the description of the second thermoplastic molding composition. It is also possible to use mixtures of additives.

Particularly preferred first thermoplastic molding compositions comprise compositions which comprise not only thermoplastic polymer, catalyst, and, where appropriate, coupling agents and/or, where appropriate, stabilizers, in particular antioxidants and/or, where appropriate, UV stabilizers and/or, where appropriate, processing aids, such as waxes, and/or, where appropriate, nucleating agents as additives whose presence does not adversely affect the activity of the catalyst used.

Examples of antioxidants are sterically hindered phenol compounds.

Examples of UV stabilizers are benzotriazole derivatives and benzophenone derivatives.

The first thermoplastic molding composition is preferably in essence composed of thermoplastic polymer, of catalyst, and, where appropriate, of antioxidant.

Very particularly preferred first thermoplastic molding compositions are compositions which, besides the thermoplastic polymer, are then composed only of at least one catalyst and of at least one antioxidant.

The proportions of catalyst here are preferably from 0.00001 to 0.5% by weight, and the proportions of the antioxidant here are preferably from 0.01 to 1.0% by weight, based on the proportion of the first thermoplastic molding composition.

The selection of the constituents of the first molding composition is to be such as to ensure that these comprise no constituents which adversely affect the activity of the catalyst. The selection criteria for this can be determined by the person skilled in the art via routine experiments.

Experiments which can serve to establish an adverse effect of an additive on the activity of the catalyst are those in which the same resultant amounts of the relevant additive, i.e. the same amounts of the additive in the final molding, are added to the first thermoplastic molding composition and, respectively, to the second thermoplastic molding composition. An adverse effect on the activity of the catalyst (in the first molding composition) is present if, given identical added amounts of the catalyst, the pellets produced by means of the process described and comprising the additive in the first thermoplastic molding composition, or the moldings produced therefrom, e.g. rods, have poorer mechanical properties than the corresponding pellets or moldings which comprise the additive in the second thermoplastic molding composition. By way of example, the person skilled in the art would attempt to establish this by determining the tensile strengths or tensile strain at break values of standard specimens produced via injection molding of the pellets to be compared. If at least one of the mechanical properties of the first group of standard specimens (derived from pellets which comprise the additive in the first thermoplastic molding composition) is markedly, e.g. 10%, poorer than the corresponding mechanical property of the second group of standard specimens (derived from pellets which comprise the additive in the second thermoplastic molding composition), it can be concluded that the additive has adversely affected the activity of the catalyst.

Formation of covalent bonds between the thermoplastic polymer and surface of the multifilaments generally takes place before the material has left the first impregnator and/or during further processing of the pultruded semifinished product.

Particular preference is given to first thermoplastic molding compositions composed of polyoxymethylenehomo- or copolymer.

The proportion of the multifilaments in the strand leaving the first impregnator is generally up to 80% by weight, preferably from 10 to 80% by weight, based on the weight of this strand.

Suitable catalysts which can be used in the first thermoplastic molding composition are in principle any of the compounds which catalyze a chemical reaction in which covalent bonds form between the matrix polymer and the material of the multifilaments. This may involve either the reaction of reactive groups of the matrix polymer with reactive groups on the surface of the multifilaments, or else may involve chemical reactions in which covalent bonds are formed between coupling agents used and polymer matrix and/or the surface of the multifilaments, or in which covalent bonds form between two portions of a coupling agent, of which one of the portions is compatible with the matrix polymer and the other portion is compatible with the surface of the multifilament additive.

Examples of inventively catalyzed reactions for formation of covalent bonds between the thermoplastic matrix polymer and the surface of the multifilaments are any of the reactions in which covalent bonds form between identical or different reactive groups.

Examples of reactive groups are hydroxy groups, thiol groups, mercaptan groups, amine groups, ester groups, amide groups, anhydride groups, carboxy groups, carbonate groups, sulfonic acid groups, expoxy groups, urethane groups, thiourethane groups, isocyanate groups, allophanate groups, urea groups, biuret groups, lactone groups, lactam groups, oxazolidine groups, and carbodiimide groups, and halogen atoms.

Examples of chemical reactions are reactions between identical reactive groups, e.g. transesterification reactions, transamidation reactions, or transurethanization reactions; or reactions between different reactive groups, e.g. ester formation, amide formation, or urethane formation, or formation of carbon-carbon bonds.

Catalysts used according to the invention are preferably compounds which catalyze transesterification reactions, transamidation reactions, or transurethanization reactions, or which catalyze the formation of ester groups, amide groups, and urethane groups.

It is advantageous to use Lewis acids, these particularly preferably not being Brönsted acids.

According to the invention, the usual amounts used of these catalysts are from 0.00001 to 1.0% by weight, advantageously from 0.0005 to 0.5% by weight, and particularly advantageously from 0.0007 to 0.01% by weight, in particular from 0.0007 to 0.005% by weight, based on the first thermoplastic molding composition.

Examples of suitable catalysts are MgX₂, BiX₃, SnX₄, SbX₅, FeX₃, GaX₃, HgX₂, ZnX₂, AlX₃, PX₃, TiX₄, MnX₂, ZrX₄, [R₄N]⁺_{q}A^{q-}, [R₄P]⁺_{q}^{A-}, where X can be a halogen atom, i.e. I, Br, Cl, F, and/or an —O—R or —R group, where R is alkyl or aryl, q is a whole number from 1 to 3, and A is a q-valent anion, such as halide, sulfate, or carboxylate.

It is also possible to use mixtures of different catalysts. Other particularly advantageous catalysts are selected from the group consisting of phosphonium salts, phosphanes, ammonium salts, sulfonium salts, titanates, titanyl compounds, zirconates, and mixtures of these.

Titanates or zirconates which can be used with particular advantage are tetraalkyl titanates and tetraalkyl zirconates having identical or different alkyl radicals having from 1 to 20 carbon atoms, advantageously from 2 to 10 carbon atoms, in particular from 3 to 8 carbon atoms.

Compounds that can be used with particular advantage are titanium tetrabutoxide, zirconium tetrabutoxide, tetrapentyl titanate, tetrapentyl zirconate, tetrahexyl titanate, tetraisobutyl titanate, tetraisobutyl zirconate, tetra-tert-butyl titanate, tetra-tert-butyl zirconate, triethyl tert-butyl titanate, or triethyl tert-butyl zirconate.

Phosphonium salts which can be used with preference advantageously bear, as at least one aryl radical, at least one phenyl radical, examples being tetraphenylphosphonium chloride or tetraphenylphosphonium bromide.

It is particularly preferable to use phosphonium salts which comprise not only aromatic but also aliphatic radicals, in particular three aryl radicals, examples being phenyl radicals. Examples of this last-mentioned group are ethyltriphenylphosphonium chloride, ethyltriphenylphosphonium bromide.

The statements made in relation to the phosphonium salts are also applicable analogously to the ammonium salts.

Triphenylphosphane P(C₆H₅)₃ is used as particularly advantageous phosphane.

For the purposes of the invention, thermoplastic polymers are in principle any of the known, synthetic, naturally occurring, and modified naturally occurring polymers which can be processed via melt extrusion. These thermoplastic polymers are used in the first and second thermoplastic molding composition.

By way of example, mention may be made of:

polylactones, such as poly(pivalolactone) or poly(caprolactone);

polyurethanes, such as the polymerization products of the diisocyanates, e.g. of naphthalene 1,5-diisocyanate; p-phenylene diisocyanate; m-phenylene diisocyanate, tolylene 2,4-diisocyanate, tolylene 2,6-diisocyanate, diphenylmethane 4,4′-diisocyanate, 3,3′-dimethylbiphenyl 4,4′-diisocyanate, diphenylisopropylidene 4,4′-diisocyanate, 3,3′-dimethyldiphenyl 4,4′-diisocyanate, 3,3′-dimethyldiphenylmethane 4,4′-diisocyanate, 3,3′-dimethoxybiphenyl 4,4′-diisocyanate, dianisidine diisocyanate, toluidine diisocyanate, hexamethylene diisocyanate, 4,4′-diisocyanatodiphenylmethane, hexamethylene 1,6-diisocyanate, or dicyclohexylmethane 4,4′-diisocyanate with polyesters derived from long-chain diols, e.g. poly(tetramethylene adipate), poly(ethylene adipate), poly(butylene 1,4-adipate), poly(ethylene succinate), poly(butylene 2,3-succinate), polyether diols, and/or with one or more diols such as ethylene glycol, propylene glycol, and/or with polyether diols derived from one or more diols, e.g. diethylene glycol, triethylene glycol, and/or tetraethylene glycol;

polycarbonates, such as poly[methanebis(phenyl 4-carbonate)], poly[1,1-etherbis(phenyl 4-carbonate)], poly[diphenylmethanebis(phenyl 4-carbonate)], and poly[1,1-cyclohexanebis(phenyl 4-carbonate)];

polysulfones, such as the reaction product of the sodium salt of 2,2-bis(4-hydroxyphenyl)propane or of 4,4′-dihydroxydiphenyl ether with 4,4′-dichlorodiphenyl sulfone;

polyethers, polyketones, and polyether ketones, such as polymerization products of hydroquinone, of 4,4′-dihydroxybiphenyl, of 4,4′-dihydroxybenzophenone, or of 4,4′-dihydroxydiphenylsulfone with dihalogenated, in particular difluorinated or dichlorinated, aromatic compounds of the type represented by 4,4′-dihalodiphenyl sulfone, 4,4′-dihalodibenzophenone, bis(4,4′-dihalobenzoyl)benzene, and 4,4′-dihalobiphenyl;

polyamides, such as poly(4-aminobutanoate), poly(hexamethyleneadipamide), poly(6-aminohexanoate), poly(m-xylyleneadipamide), poly(p-xylylenesebacamide), poly(2,2,2-trimethylhexamethyleneterephthalamide), poly(meta-phenyleneisophthalamide) (NOMEX), and poly(p-phenyleneterephthalamide) (KEVLAR);

polyesters, such as poly(ethylene 1,5-naphthalate), poly(cyclohexane-1,4-dimethylene terephthalate), poly(ethylene oxybenzoate) (A-TELL), poly(parahydroxybenzoate) (EKONOL), poly(cyclohexylidene-1,4-dimethylene terephthalate) (KODEL), polyethylene terephthalate, and polybutylene terephthalate;

poly(arylene oxides), such as poly(2,6-dimethylphenylene 1,4-oxide), and poly(2,6-diphenylphenylene 1,4-oxide);

liquid-crystalline polymers, such as the polycondensation products from the group of monomers consisting of terephthalic acid, isophthalic acid, naphthalene-1,4-dicarboxylic acid, naphthalene-2,6-dicarboxylic acid, biphenyl-4,4′-dicarboxylic acid, 4-hydroxybenzoic acid, 6-hydroxy-2-naphthalenedicarboxylic acid, hydroquinone, 4,4′-dihydroxybiphenyl, and 4-aminophenol;

poly(arylene sulfides), such as poly(phenylene sulfide), poly(phenylene sulfide ketone), and poly(phenylene sulfide sulfone);

polyetherimides;

polyoxymethylenehomo- or copolymers;

vinyl polymers and their copolymers, such as polyvinyl acetate, polyvinyl chloride, polyvinyl butyral, polyvinylidene chloride, and ethylene-vinyl acetate copolymers;

polyacrylic derivatives, such as polyacrylate and polymethacrylate and their copolymers and derivatives, such as esters, for example polyethyl acrylate, poly(n-butyl acrylate), poly(methyl methacrylate), poly(ethyl methacrylate), poly(n-butyl methacrylate), poly(n-propyl methacrylate), polyacrylonitrile, water-insoluble ethylene-acrylic acid copolymers, water-insoluble ethylene-vinyl alcohol copolymers, acrylonitrile copolymers, methyl methacrylate-styrene copolymers, ethylene-ethyl acrylate copolymers, and acrylic-butadiene-styrene copolymers;

polyolefins, such as poly(ethylene), e.g. low-density poly(ethylene) (LDPE); linear low-density poly(ethylene) (LLDPE) or high-density poly(ethylene) (HDPE);

poly(propylene), chlorinated poly(ethylene), e.g. chlorinated low-density poly(ethylene);

poly(4-methyl-1-pentene), and (poly)styrene);

water-insoluble ionomers; poly(epichlorohydrin);

furan polymers, such as poly(furan);

cellulose esters, such as cellulose acetate, cellulose acetate butyrate, and cellulose propionate;

silicones, such as poly(dimethylsiloxane), and poly(dimethylsiloxane-co-phenylmethylsiloxane);

protein thermoplastics;

and also all of the mixtures and alloys (miscible and immiscible blends) of two or more of the polymers mentioned.

For the purposes of the invention, thermoplastic polymers also encompass thermoplastic elastomers derived, for example, from one or more of the following polymers:

polyurethane elastomers, fluoroelastomers, polyesterelastomers, polyvinyl chloride, thermoplastic butadiene/acrylonitrile elastomers, thermoplastic poly(butadiene), thermoplastic poly(isobutylene), ethylene-propylene copolymers, thermoplastic ethylene-propylene-diene terpolymers, thermoplastic sulfonated ethylene-propylene-diene terpolymers, poly(chloroprene), thermoplastic poly(2,3-dimethylbutadiene), thermoplastic poly(butadiene-pentadiene), chlorosulfonated poly(ethylene), block copolymers composed of segments of amorphous or (semi)crystalline blocks, e.g. poly(styrene), poly(vinyltoluene), poly(tert-butylstyrene), and polyesters, and of elastomeric blocks, such as poly(butadiene), poly(isoprene), ethylene-propylene copolymers, ethylene-butylene copolymers, ethylene-isoprene copolymers, and their hydrogenated derivatives, for example SEBS, SEPS, SEEPS, and also hydrogenated ethylene-isoprene copolymers having an increased proportion of 1,2-linked isoprene, polyethers, styrene polymers, such as ASA (acrylonitrile-styrene-acrylate), ABS (acrylonitrile-butadiene-styrene), or PC/ABS (polycarbonate/ABS) and the like, for example the products marketed with the trade mark KRATON from Kraton Polymers, and also any of the mixtures and alloys (miscible and immiscible blends) of two or more of the polymers mentioned.

Use may also advantageously be made of block copolymers which contain blocks having functional groups capable of reaction with the additives.

Materials which may likewise advantageously be used as matrix polymer or in particular as additives to the matrix polymer are graft copolymers in which functional groups which become involved in one of the reactions mentioned above, such as transesterification reactions, are present in a side chain; these are in particular modified polyolefins, particularly modified polyethylene or modified polypropylene. The modified polyolefin preferably contains at least one of the following groups: carboxy, carboxylic anhydride, metal carboxylate, carboxylic ester, imino, amino, or epoxy group, advantageously at from 1 to 50% by weight.

Examples of these polyolefins having functional groups encompass modified polyolefin copolymers or grafted copolymers which are produced by chemical grafting of the following compounds listed by way of example, e.g. maleic anhydride, citric anhydride, N-phenylmaleimide, N-cyclohexylmaleinimide, glycidyl acrylate, glycidyl methacrylate, glycidyl vinylbenzoate, N-[4-(2,3-epoxypropoxy)-3,5-dimethylbenzyl]acrylamide (AXE), or alkyl(meth)acrylates onto polyolefins, such as polypropylene, polyethylene, or ethylene-propylene copolymers, or onto polyamide. There is no restriction on the degree of polymerization of the modified polymer, and it may also be an oligomer.

Particularly preferred modified polyolefins are maleic-anhydride-modified polyethylene, maleic-anhydride-modified polypropylene, maleic-anhydride-modified polyethylene-polypropylene copolymer, glycidyl-methacrylate-modified polyethylene, glycidyl-methacrylate-modified polypropylene, AXE-modified polyethylene, AXE-modified polypropylene, and polyamide-grafted polyolefins.

It is very particularly advantageous to use polymers which are obtainable via transesterification reactions, transamidation reactions, or transurethanization reactions, or whose repeat unit contains at least one group which can become involved in this type of reaction or a similar reaction.

The thermoplastic polymers which may be used with particular advantage and contain functional groups which can become involved in transesterification, transamidation or transurethanization reactions can advantageously be used in a mixture with polymers which contain no functional groups which cannot become involved in reactions of this type, thus improving their coupling to the multifilaments.

For production of long-fiber-reinforced thermoplastics structures using polypropylene it is therefore advantageously possible to add at least one modified polyolefin and/or polyamide to the polypropylene to be used.

Thermoplastic polymers to be used with very particular advantage are polyamides, polyesters, polycarbonates, polyarylene sulfides and polyacetals, polyolefins, in particular combined with modified polyolefins.

The catalyst or the catalyst mixture and, if appropriate, the other additives used can be incorporated into the thermoplastic of the first thermoplastic molding composition by processes known per se, for example by means of an extruder or kneader. This has preferably been installed upstream of the first impregnator, or pellets are used, composed of thermoplastic molding compositions whose formation occurred at an earlier stage.

The second thermoplastic molding composition differs from the first thermoplastic molding composition. The second thermoplastic molding composition generally comprises no catalyst, but catalyst has to be present in the first thermoplastic molding composition.

The second thermoplastic molding composition can be composed exclusively of thermoplastic or of a mixture of thermoplastics, but comprises at least one additive.

These can be any desired additives which can be useful during the processing of the pultruded semifinished product and/or give the subsequent final product a desired property.

Examples of additives are mineral fillers, colorants, antistatic agents, lubricants, tribological auxiliaries, antioxidants, UV stabilizers, acid scavengers, coupling agents, mold-release agents, nucleating agents, ultrahigh-molecular-weight polyethylene, impact modifiers, in particular elastomers. It is also possible to use mixtures of additives.

Examples of mineral fillers are chalk, calcium carbonate, glass beads, hollow glass beads, talc, wollastonite, loam, molybdenum disulfide, and/or graphite.

Examples of antioxidants are sterically hindered phenol compounds. Examples of UV stabilizers are benzotriazole derivatives and benzophenone derivatives.

Examples of antistatic agents and, respectively, additives providing conductivity are carbon blacks, in particular conductive carbon blacks, or metal powders.

An example of a nucleating agent is talc.

Examples of colorants are inorganic pigments, such as titanium dioxide, ultramarine blue, cobalt blue, or organic pigments and dyes, such as phthalocyanines, anthraquinones.

Examples of lubricants are soaps and esters, such as stearyl stearate, montanic esters, partially hydrolyzed montanic esters; stearic acids, polar and/or non-polar polyethylene waxes, poly-α-olefin oligomers, silicone oils, polyalkylene glycols and perfluoroalkyl ethers, polytetrafluoroethylene.

By virtue of the absence of problematic additives in the core of the pultruded rod, adverse effects on the activity of the catalyst located in the core are excluded.

In one preferred embodiment, additives used in the second thermoplastic molding composition are present in a separate phase in the polymer matrix.

These additives are particularly preferably used together with a catalyst which catalyzes formation of covalent bonds between the thermoplastic polymer and the surface of the additive, so that its surface can be bonded covalently to the polymer matrix via a chemical reaction.

The additives can be typical reinforcement substances, such as fibers, ligaments, films, or fiber sheet structures, or typical fillers used mainly for economic reasons, e.g. mineral fillers, or else fillers used to give the composition a desired property, e.g. to achieve a reinforcement effect, or else impact modifiers.

These additives have advantageously been provided with a size or have been surface-treated in order to improve coupling to the plastics matrix.

The additives may be incorporated into the thermoplastic of the second thermoplastic molding composition by processes known per se, for example by means of an extruder or kneader. This has preferably been installed upstream of the second impregnator, or use is made of pellets composed of thermoplastic molding compositions whose formation occurred at an earlier stage.

Particularly preferred additives used in the second thermoplastic molding composition are impact modifiers. The catalysts preferably used in the second thermoplastic molding composition also improve compatibility and dispersibility of the impact modifiers in the polymer matrix, the result being higher impact resistances.

The manner in which this takes place is that “in situ”, i.e. during the melt-kneading procedure, a coupling reaction is catalytically promoted between the thermoplastic polymer and available functionalities of the impact modifier, and this may be regarded as producing a block copolymer which improves thermodynamic miscibility and therefore compatibility within the mixture, by acting as compatibilizer across the phase boundary.

Impact modifiers which may be used with preference are, individually or in the form of a mixture, polyurethanes, two-phase mixtures composed of polybutadiene and styrene/acrylonitrile (ABS), modified polysiloxanes and, respectively, silicone rubbers, or graft copolymers composed of an elastomeric, single-phase core based on polydiene and of a hard graft shell (core-shell structure).

The second thermoplastic molding composition used according to the invention can comprise amounts of additives which are usually up to 40% by weight, individually or in the form of a mixture, based on the weight of the second thermoplastic molding composition.

The proportion of the thermoplastic polymer(s) in the second thermoplastic molding composition is usually from 40 to 99.9% by weight, preferably from 60 to 99% by weight, based on the total weight of the second thermoplastic molding composition.

The proportion of the additives in the second thermoplastic molding composition is preferably from 0.1 to 60% by weight, preferably from 1.0 to 40% by weight, based on the total weight of the second thermoplastic molding composition.

The invention also provides the pultruded sheathed strands which are obtainable by the process described and in which the first thermoplastic molding composition is in essence composed of thermoplastic polymer, catalyst, where appropriate coupling agent, where appropriate antioxidants, and/or, where appropriate, UV stabilizers, and where the second thermoplastic molding composition comprises additives.

The sheathed strands obtainable by the inventive process can be used as semifinished products for production of fiber-reinforced moldings. The application sectors for the final products are diverse and by way of example concern components for vehicle applications, for example for automobiles, components for household devices, or components for sports equipment.

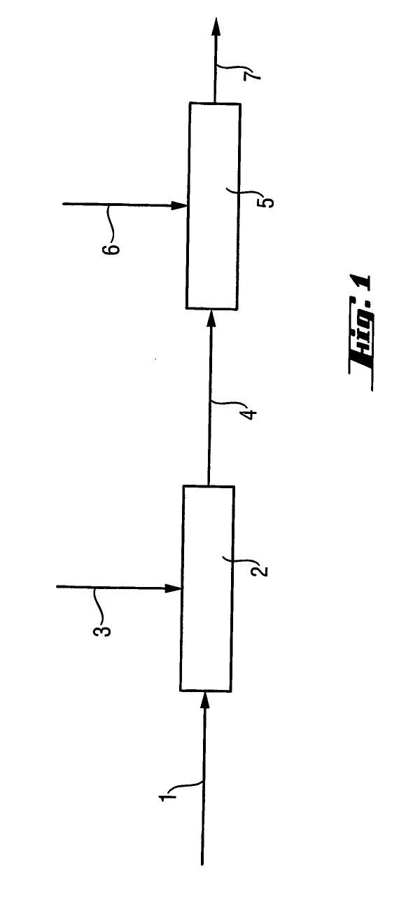

FIG. 1 shows one embodiment of the inventive process in the form of a flow diagram.

A multifilament strand (1), and also the first thermoplastic molding composition (3) are introduced into the first die (2), where they are processed to give a fiber-reinforced strand (4). This leaves the first die (2) and is introduced into a second die (5) in which it is sheathed with a second thermoplastic molding composition (6) to produce the final product (7).

### EXAMPLES

The examples below illustrate the invention but do not restrict the same.

The parent material used for experiments 1-2 comprised polyoxymethylene (POM) from Ticona GmbH. Other auxiliaries used corresponding to the composition stated in the table below comprised a mixture comprising nucleating agent, antioxidant, and mold-release agent. Ethyltriphenylphosponium bromide was used as catalyst.

Experiment 1 is a comparative example. Experiment 2 is an example according to the invention.

Example 1 is single-stage pultrusion. Example 2 is two-stage pultrusion which was carried out in an arrangement, outlined in FIG. 1, of two dies, and in which the use of the components “tribological additive” and “carbon black” is spatially and chronologically separate and is delayed until the second die has been reached.

The individual dosages added to the respective dies are found in the table below. The following abbreviations have been used here:

F_{w}1=proportion of the multifilament strand introduced to the die 1 in % by weight, based on the weight of the pultruded strand leaving this die.

G_{w}1=proportion of the first thermoplastic molding composition introduced to the die 1 in % by weight, based on the weight of the pultruded strand leaving this die.

F_{w}2=proportion of the pultruded strand introduced to the die 2 in % by weight, based on the weight of the sheathed pultruded strand leaving this die.

G_{w}2=proportion of the second thermoplastic molding composition introduced to the die 2 in % by weight, based on the weight of the sheathed pultruded strand leaving this die.

The mixing constituents forming the first and, respectively, second thermoplastic molding composition were mixed, then melted in a twin-screw extruder, homogenized, drawn off in the form of a strand, and pelletized. In turn, these pellets were then added to die 1 and, respectively, die 2 of the pultrusion plant outlined in FIG. 1, and remelted in an extruder, and homogenized, and the melt was compressed into the appropriate dies for impregnation of the pultrusion strand.

To produce test specimens, the chopped pultrusion strands were processed via injection molding to give standard test specimens and characterized by the methods listed below:

tensile strength, tensile strain at break, and tensile modulus of elasticity were determined in the tensile test to ISO 527.

Charpy knotched impact resistance and impact resistance were determined in the tensile impact test to ISO 176.

The amounts in the table below are stated in percent by weight (% by wt.). Tensile strength and tensile modulus of elasticity are stated in MPa, tensile strain at break is in %, and impact resistances are stated in kJ/m². The properties were determined in accordance with the DIN and, respectively, ISO standards stated in the table.

The table contains the compositions of the mixtures for die 1 and die 2, and the corresponding test results.

TABLE

| Constituent/properties | Method | Unit | 1 | 2 |
|---|---|---|---|---|
| F_{w}1 | | % by wt. | 25 | 40 |
| Polyoxymethylene copolymer | | % by wt. | 90.7800 | 97.6759 |
| Auxiliaries (stabilizers, waxes) | | % by wt. | 2.1467 | 2.3097 |
| Tribological additive | | % by wt. | 6.6667 | — |
| Ethyltriphenylphosphonium | | % by wt. | 0.0067 | 0.0143 |
| bromide | | | | |
| Additive (carbon black) | | % by wt. | 0.4000 | — |
| G_{w}1 | | % by wt. | 75 | 60 |
| F_{w}2 | | % by wt. | — | 62.5 |
| Polyoxymethylene copolymer | | % by wt. | — | 84.7936 |
| Auxiliaries (stabilizers, waxes) | | % by wt. | — | 2.0051 |
| Additive (lubricant) | | % by wt. | — | 12.4541 |
| Ethyltriphenylphosphonium | | % by wt. | — | — |
| bromide | | | | |
| Additive (carbon black) | | % by wt. | — | 0.7472 |
| G_{w}2 | | % by wt. | — | 37.5 |
| Fiber content | DIN ISO 3451-1 | % by wt. | 25 | 25 |
| Tensile strength | DIN ISO 527; 5 mm/min | MPa | 121 | 132 |
| Tensile strain at break | DIN ISO 527; 5 mm/min | % | 1.9 | 2.3 |
| Tensile modulus of elasticity | DIN ISO 527; 1 mm/min | MPa | 9 | 8.7 |
| Knotched impact resistance | ISO 179 | kJ/m² | 40.0 | 47.6 |
| (Charpy, 23° C.) | | | | |
| Impact resistance | ISO 179 | kJ/m² | 12.0 | 13.8 |
| (Charpy, 23° C.) | | | | |

1. A process for production of long-fiber-reinforced molding compositions encompassing the steps of:
a) passing, over a surface, at least one multifilament strand of multifilaments subject to tension, so that in the at least one strand the multifilaments spread apart and form an opened multifilament strand,
b) introducing the opened multifilament strand subject to tension into a first impregnator,
c) conducting a first thermoplastic molding composition into the first impregnator, where the first thermoplastic molding composition comprises at least one thermoplastic polymer, at least one catalyst which catalyzes the formation of covalent bonds between the thermoplastic polymer and the surface of the multifilaments, and optionally comprises other additives which do not adversely affect the activity of the catalyst,
d) impregnating the at least one opened multifilament strand with the plastified first thermoplastic molding composition,
e) drawing-off of the fiber-reinforced strand formed from the first impregnator,
f) passing the fiber-reinforced strand into a second die,
g) conducting a second thermoplastic molding composition, other than the first thermoplastic molding composition and comprising at least one thermoplastic polymer and comprising additives, into the second die,
h) sheathing the fiber-reinforced strand with the plastified second thermoplastic molding composition in the second die,
i) drawing-off of the fiber-reinforced strand provided with a sheath composed of the second thermoplastic molding composition from the second die, and
j) optionally cooling, molding, pelletizing and/or further processing of the fiber-reinforced strand provided with a sheath composed of the second thermoplastic molding composition.

2. The process as claimed in claim 1, wherein a plurality of opened multifilament strands are introduced into the first impregnator.

3. The process as claimed in claim 1, wherein the fiber-reinforced strand provided with a sheath composed of the second thermoplastic molding composition is cooled, molded, chopped into pellets, and/or further processed after leaving the second die.

4. The process as claimed in claim 1, wherein the first thermoplastic molding composition is substantially composed of at least one thermoplastic polymer, of at least one catalyst, and optionally of at least one antioxidant, and wherein the proportion of the multifilaments is from 10 to 80% by weight, based on the weight of the fiber-reinforced rod leaving the first impregnator.

5. The process as claimed in claim 1, wherein the catalyst in the first molding composition is a catalyst which catalyzes transesterification, transamidation, or transurethanization reactions, or which catalyzes the formation of ester groups, amide groups, and urethane groups.

6. The process as claimed in claim 1, wherein the catalyst in the first molding composition is a Lewis acid.

7. The process as claimed in claim 1, wherein the catalyst in the first molding composition is selected from the group consisting of phosphonium salts, phosphanes, ammonium salts, sulfonium salts, titanates, titanyl compounds, zirconates, and mixtures of these.

8. The process as claimed in claim 1, wherein the additive in the second molding composition is selected from the group consisting of mineral fillers, colorants, antistatic agents, lubricants, tribological auxiliaries, antioxidants, UV stabilizers, acid scavengers, coupling agents, mold-release agents, nucleating agents, ultrahigh-molecular-weight polyethylene, impact modifiers, elastomers, and mixtures thereof.

9. The process as claimed in claim 1, wherein, in the second molding composition, additives are used which are present in a separate phase in the polymer matrix.

10. The process as claimed in claim 1, wherein the thermoplastic polymer for the first molding composition and/or the second molding composition is selected from the group consisting of polyolefin polyacrylate, polymethacrylate, polymers obtainable by polymerizing esters and/or amides of acrylic acid or methacrylic acid, copolymers of these, polyamides, polyesters, polycarbonate, polyethers, polythioethers, polyacetals, polyphenylene oxides, polyarylene sulfides, and mixtures of these.

11. The process as claimed in claim 1, wherein the catalyst in the first molding composition is selected from the group consisting of ethyltriphenylphosphonium bromide, tetraphenylphosphonium bromide, tetrabutylphosphonium bromide, stearyltributylphosphonium bromide, triphenylphosphane, n-butyl titanate, and mixtures of these.

12. A fiber-reinforced and thermoplastic-sheathed strand composed of a first fiber-reinforced thermoplastic molding composition which is sheathed with a second thermoplastic molding composition and which is obtainable by the process as claimed in claim 1, where the first thermoplastic molding composition is substantially composed of thermoplastic polymer, catalyst, where appropriate coupling agent, optionally antioxidants, and/or, optionally UV stabilizers, and where the second thermoplastic molding composition comprises additives.

13. A fiber-reinforced molding obtainable by shaping the fiber-reinforced and thermoplastic-sheathed strand as claimed in claim 12 or by shaping of pellets produced by comminuting the fiber-reinforced and thermoplastic-sheathed strand as claimed in claim 12.

14. The use of the sheathed strands obtainable by the process as claimed in claim 1 for producing fiber-reinforced moldings for use as components for vehicle applications, for household devices, or for sports.

15. The process as claimed in claim 1, wherein from one to a hundred of opened multifilament strands are introduced into the first impregnator.

16. The process as claimed in claim 1, wherein the additive in the second molding composition is elastomer.

17. The process as claimed in claim 1, wherein the thermoplastic polymer for the first molding composition and/or the second molding composition is selected from the group consisting of polypropylene, polyethylene, a modified polyolefin; polyacrylate, polymethacrylate, polymers obtainable by polymerizing esters and/or amides of acrylic acid or methacrylic acid, copolymers of these, polyamides, polyesters, polycarbonate, polyethers, polythioethers, polyacetals, polyphenylene oxides, polyarylene sulfides, and mixtures of these.
